(19) United States
(12) Patent Application Publication
(10) Pub. No.: US 2008/0120231 A1
(43) Pub. Date: May 22, 2008

(54) Money refillable credit card

(76) Inventor: Charles Megwa, Stoughton, MA (US)

Correspondence Address: LAMBERT & ASSOCIATES, P.L.L.C., 92 STATE STREET, BOSTON, MA, 02109-2004, US

(21) Appl. No.: 11/600,482

(22) Filed: Nov. 16, 2006

(51) Int. Cl. G06Q 40/00

(52) U.S. Cl. 705/41; 705/39

(57) ABSTRACT

A credit containment card and accompanying system affords a user the ability to purchase a card which can transfer or receive funds from either a bank or credit card administrator, but is not limited to any individual of these providers. The system includes four main functional components: a plurality of cards, a plurality of terminals, a network apparatus and a central administrative apparatus. Each of the cards having a security number, and/or sub security numbers associated therewith. The central administrative apparatus includes a database for storing security numbers. The terminals also include terminals located within purchasing centers and stand alone terminals, reminiscent of banking ATM systems.

### BACKGROUND OF THE INVENTION

1. Field of Invention

The present invention relates generally to pre-paid services and more particularly to a pre-paid card systems having a remote terminal to provide on-site activation and replenish and discharging of cards in customer-defined amounts.

2. Background of the Invention

Throughout this application, various publications are referenced. The disclosures of these publications in their entireties are hereby incorporated by reference into this application in order to more fully describe the state of the art as known to those skilled therein as of the date of the invention described and claimed herein.

Pre-paid card services are known in the varying arts, including the credit card and telephone realm, as well as differing service industries. In recently developed prior art systems, cards loaded in varying monetary or time denominations (depending on the genre of service provided) and disseminated by card providers over a counter or in machines.

In many prior inventions, such as telephonic cards or travelers checks, for a specific fee, a vessel is purchased by the customer with an established value. For many credit cards, a provider issues a line of credit, a user makes purchases upon the card and remits payment upon billing by the administrator. In this manner, interest is paid on a balance. Thus, there is a need for a card with which people are not charged fees to access money.

Further while replenishable cards for purchasing do presently exist, none possess the capability to transfer funds from the card, back to accounts. Such a capability would be important in case of theft of a card. Thus, there is a need for a card which allows the user the ability transfer some or all funds from the card back to accounts.

A major drawback found in present systems centers on security issues occurring when the card is lost, especially when traveling. In this situation, present inventions subject the owner of the card to complete diminishment of a monetary or telephonic minute balance and possible excess charges on a credit card. Thus, there is a need for a card to which funds may be replenished from a bank account or credit card account and also from which funds can be removed or transferred upon the needs of the user.

3. Description of the Related Art

Investigating references within the instant art, Stimson et al., U.S. Pat. No. 5,577,109, discloses a pre-paid card system that enables customers to make purchases using an authorized card. The invention relates generally to pre-paid services and more particularly to a pre-paid card system having a remote terminal to provide on-site activation and recharging of cards in customer-identified amounts. Most relevant to your invention, one embodiment of the Stimson et al. invention allows a user to activate or recharge a pre-paid card with an authorized dollar amount at a user activation terminal. The pre-paid card may then be used to purchase various goods and services up to the authorized dollar amount. This reference discloses a system for managing the cards by which there is a main processor that includes a host computer which manages the purchasing network and stores the security information associated with each card.

Taskett et al., U.S. Pat. No. 5,991,748, discloses an improved system for “regenerating” or adding funds to prepaid, remote memory account. This system relates generally to a transaction card for purchasing goods or services and, more particularly, to methods and apparatus for transferring funds or prepaying a transaction card and its associated remote memory account. Most relevant to your invention, this reference discloses a system by which users may remotely recharge their pre-paid card, either automatically based on stored information in the host computer or via telephone at the customer's request.

Levine et al., U.S. Pat. No. 5,477,038, discloses a process which provides electronic access to pre-paid funds for case or payment for goods and services. A card is issued to a customer with a value selectable by the customer. The card has a magnetic stripe encoded with account-specific information and is protected by a PIN number. When the customer purchases the card, the sales agent transmits to a central data base computer, which activates the account and establishes the card's balance in the amount for which the customer paid. The customer may then use the card to acquire cash or purchase goods and services.

Hogan, U.S. Pat. No. 5,557,516, discloses a cashless transaction system which includes a storage device for system users (e.g. an integrated circuit card or credit card with magnetic stripe) and sales or transaction terminals (e.g. soda or toll machine) which accept the storage device and which include a microprocessor located within the terminal which can read, compare, and write back data to the storage device.

Halpern, U.S. Pat. No. 4,906,828, discloses a value-adding cycle in which the card holder goes to an authorized mediator point such as post office, bank or licensed supermarket checkout point, or alternatively, performs the operation from one's own home. The goal of this invention is to fulfill multiple conditions in a single embodiment, including allowing repeated reloading of value data and debiting operations, adding any amount desired at an authorized terminal or from one's own phone, and providing adequate security measures.

Nakano et al., U.S. Pat. No. 5,987,438, discloses an electronic wallet system including an integrated circuit (IC) card; an IC card reader/writer for reading data from, and writing data into, the IC card; an IC card loader unit for loading the IC card into, and unloading the IC card from, the IC card loader unit; an IC card load controller unit for controlling a load/unload operation of the IC card; and a lock signal generator unit for generating an IC card lock signal in response to an activation of an unload operation by the IC card load controller unit. One object of this invention is to provide an electronic wallet system easy to use having high security, capable of automatically locking an IC card when it is unloaded from an IC card reader/writer, and automatically unlocking an IC card when loaded.

Pallares, U.S. Pub. No. 20060138215, discloses a system for operating a prepaid reloadable debit card. The system includes providing ancillary services associated with the prepaid reloadable debit card. The prepaid reloadable debit card is primarily directed to the “unbanked” population and may provide a means for remittance to immigrants for transferring funds to family members back home using existing ATM and credit card infrastructures.

Dillard, U.S. Pub. No. 20050145691, discloses a system which is intended to make prepaid cards, which are not attached to a bank account, available to people who do not wish to undergo the approval process associated with a traditional credit card. The Prepaid Card disclosed in this application uses an electronic system for issuance, activation, tracking activity and balances, and networking. The card as disclosed is intended to be used to purchase a wide range of goods and services, to be replenished for future use, and to prevent fraud or illegal use by photo or fingerprint protection.

### BRIEF SUMMARY OF THE INVENTION

The present invention, as described further herein imparts a novel credit containment card, which allots the user the flexibility of a normal credit card but furnishes further advantages introduced herein.

It is an object of the instant invention to make it possible for people of any age and any income bracket to utilize the advantages of a credit card, whether under supervision or independently and with as large or small a balance as desired by the user.

It is an additional object of the instant invention to introduce a credit containment card, which permits the user to dictate the amount of money carried on the card at any given time.

Additionally it is an object of the instant invention to create a system wherein the user may transfer funds from a bank institution account or a credit card account to a credit containment card. Moreover, it is an object of the instant invention to create a system wherein the user may transfer finds to a bank institution account or a credit card account from the credit containment card. Thus, it is a further objective of the instant invention to create a system that does not have to be attached to any specific bank account or credit card corporation.

It is a further objective of the instant invention to permit the acceptance and utilization of credit cards possible in a world wide forum, thus enabling and facilitating trade and an increase in business transactions for banks, credit card companies and the like.

Of highest import, it is an objective of the instant invention to render possible the introduction of credit cards to third world where the use of conventional credit cards that are on the market would normally be non-existent or impossible.

Moreover, it is an objective of the instant invention to allow the parents of teenagers to permit their children to carry credit cards for safety purposes without the need for fear of over charging or dwindling of funds in accounts. Additionally, it is an objective to allow a person to give a credit card as a gift without having to be attached to the card in any way. Additionally, it is an object of the present invention to provide a system where addition or removal of funds may be affected remotely without possession of the card.

These together with other objects of the invention, along with the various features of novelty which characterize the invention, are pointed out with particularity in the claims annexed to and forming a part of this disclosure. The invention is not limited to the embodiments described herein, thus reference should be made to the accompanying drawings and descriptive matter in which the preferred embodiments of the invention are illustrated.

### BRIEF DESCRIPTION OF THE SEVERAL VIEWS OF THE DRAWINGS

FIG. 1 is a schematic diagram illustrating the system of the present invention;

FIG. 2 illustrates the front side of the credit containment card of the present invention;

FIG. 3 illustrates the rear side of the credit containment card of the present invention;

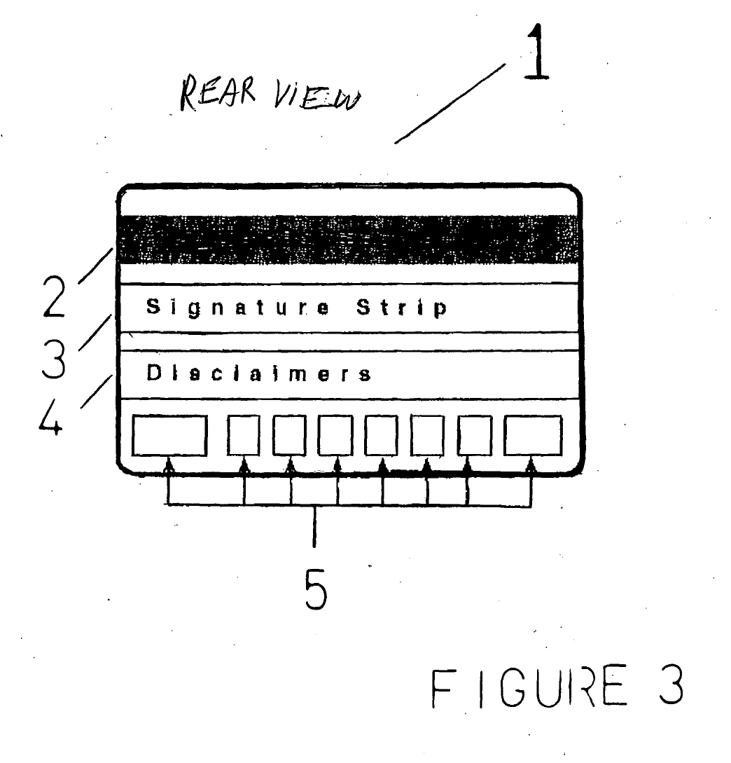

FIG. 4 is a plan view of one of the remote data terminal that can be placed in a store, purchasing center or ATM terminal.

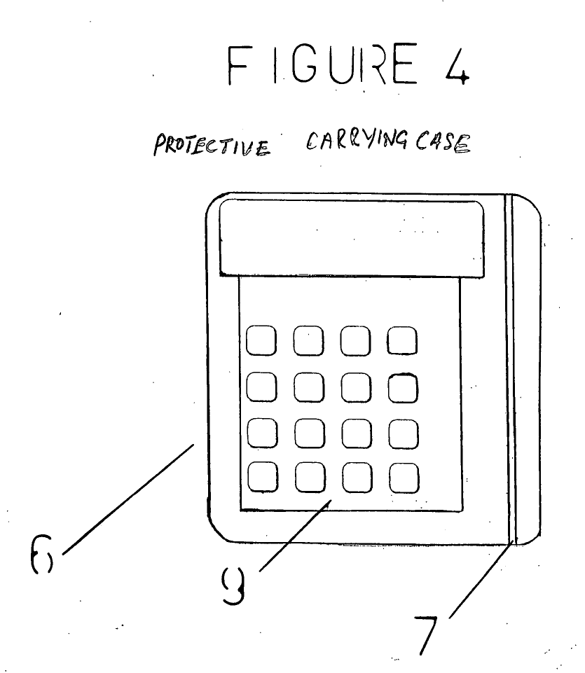

### DETAILED DESCRIPTION OF THE INVENTION

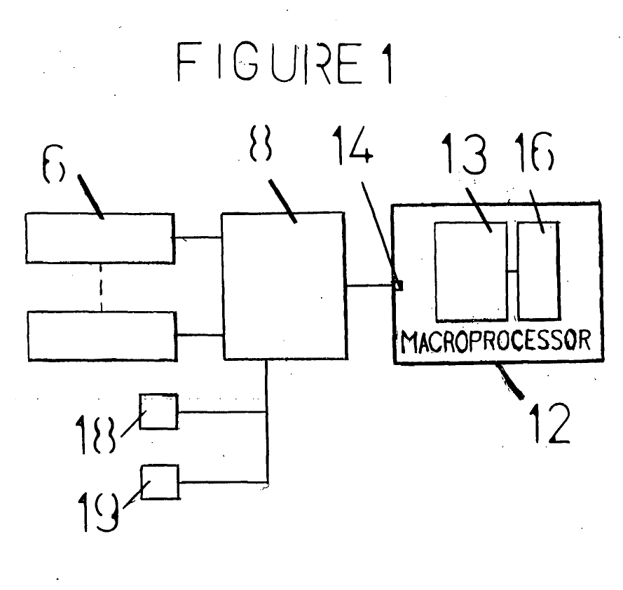

As illustrated in FIG. 1, physically, the credit containment card 1 comprises a magnetic strip or other electronic apparatus 2 for electronic communication with a receiving port in a localized terminal. The credit containment card 1 may additionally contain a signature strip 3, and a portion designated for disclaimers 4 and a portion designated for the names of the banking institutions or credit card companies 5 supporting by the individuals credit containment card 1.

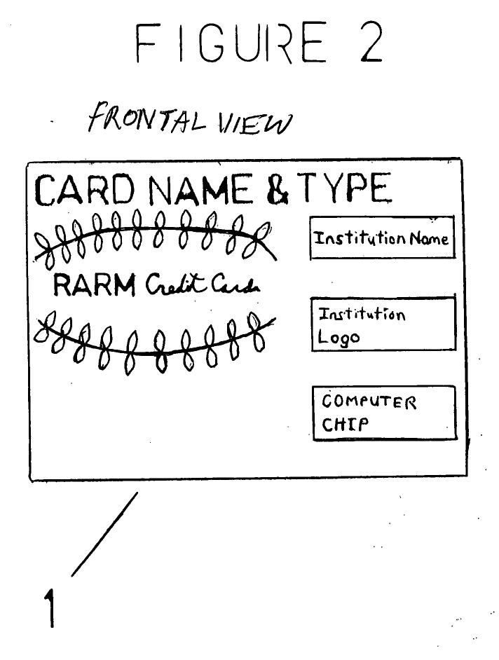

In FIG. 2, in one embodiment, a credit containment card system 30 is illustrated. This system may comprise at least one credit containment card 1, but in most effective mode will comprise a plurality of cards, each comprising an electronic communication means 2, as discussed above. The system may also include at least one electronic processing terminal apparatus 6, placed within a store or other purchasing area configured to communicate with the credit containment cards 1. The electronic processing terminal apparatus 6 may comprise at least one signal receiving port 7 in communication with an electronic network 8, at least one means for entering a security code 9, a means for transferring fund availability information to and from said at least one credit containment card 1 and an output display mechanism 11 disposed to present information pertaining to authorization of the security code, and also to display an account balance for banks and credit card company account. Further, separate booths, similar to ATM's as known in the banking and financial arts, for checking of balances, transfer of money and performance of other such functions, may exist.

The system further contains a central administrative apparatus 12 including at least one a computer 13 and in electronic communication with said network. Further, the central administrative apparatus 12 may include at least one data port 14 capable of receiving and sending information wherein said data port is capable of communication with a banking institution account server and/or a credit card account server 15. The central administrative apparatus 12 may additionally include a database 16 containing predetermined security information pertaining to the credit containment cards as issued, which, upon activation, may be changed to suit the user, from any remote station. The database 16 will also retain the amount of money that is present on the card at all times.

The central administrative apparatus 12 may additionally include an electronic information macro processing apparatus 17 capable of receiving and evaluating a security code, in conjunction with said database 16, for authorization of use of said credit containment card system for purchase in a selected institution. The information processing apparatus comprises capability to receive, send and process information regarding said banking institution accounts 18 and credit card company accounts 19 and the credit containment card should be issued with no predetermined monetary value.

Per system parameters, funds may be transferred from one or a multiplicity of banking institution accounts directly to the credit containment card at the discretion of the user. Funds may be transferred from one or a multiplicity of credit card company accounts as well. Funds may be transferred from one or a plurality of credit card company accounts while simultaneously being transferred from one or a plurality of banking institution accounts simultaneously.

Furthermore, the credit containment card system means for entering a security code means may comprise an input for verification of a government issued identification card, as opposed to a conventional security code. Additionally, the means for entering a security code comprises a keypad or other numerical entry mechanism as known in the art. The credit containment card system may also contain a capability wherein a transferal of funds allows for real time currency exchange or conversion to the country of receipt of funds, with no charge to the user. The credit containment card system may also contain the capability for funds to be transferred from said credit containment card remotely by a user without possession of said credit containment card.

Further, a pin number is utilized upon transaction and a requirement for a signed government identification card can be also be utilized.

Once purchased and activated, the card is maintained by a single system administrator, which thus enables the user to choose the mode of monetary transferal by preference or availability of funds. Therefore, the user is not limited to a single bank account and there is no control by bank or credit card company. Therefore, the instant invention vitiates the need for a credit card or debit card, especially when traveling.

Funds can be transferred to the card from multiple fund storage facilities such as banking institution accounts and credit card accounts simultaneously which can be accomplished at a terminal within a store or through outlets at stores or on street corners, etc.

Two of the utmost features of the instant system are designed, at least in part to facilitate traveling. First, the instant invention affords the user the ability to transfer funds from the credit containment card to accounts in order to achieve a zero balance without expending funds. Second, the instant invention affords the user the ability to remotely remove or add finds without having the card in possession, via telephone or other media device. Thus, the funds can be ordered ahead by the user to be physically removed from, or added to, the card upon a user swiping the card at a terminal. Thus the instant system operates as a safe travelers check which cannot be utilized without the access code.

The card may be identified as the RARM (Remote Access Refillable Money) Credit Card. The particular institutions and number of institutions to which a license to distribute the credit containment card will be the purview of the administrator. The issuing institutions will thus qualify as the exclusive institutions authorized to issue the RARM Credit Card. The credit containment card may come embody a RARM Stand Alone card or RARM Credit Cards embodiment.

With the RARM Stand alone card, the original purchaser, the primary card holder, can allot access to the credit containment card to one, or a plurality of users. While the users of the RARM Stand alone card can remotely access both the card and their own bank account only to add or reduce fund, the original purchaser can add as many authorized users as possible by adding card numbers which are considered sub-card numbers.

While the authorized user(s), sometimes referred to as sub-users, can activate their own code, also known as a sub-code, transferring existing money out of or back into the card by remote access, only the primary card holder can add funds to the card from the primary card holder's account(s). This process keeps the sub-users from getting into the primary card users line of credit or bank account as the case may be. Where the authorized user has their own personal bank account, verified, they can be allowed to add money to their authorized card without authorization from the primary. In the alternative, the sub-users may purchase their own card as opposed to remotely accessing the primary card holders card. Where an authorized card holder has an established bank account, with the authorization of the primary card holder, the authorized card holder's card could be removed from as part of the primary's sub card and become a stand alone card. This process may save the authorized card user up to 50% of the cost of purchasing a new credit containment card. This process could also be applied to the RARM Credit Card

While the RARM Stand Alone card and RARM Credit Cards are not directly linked to any specific bank account, both are indirectly or remotely linked to an administrator account. With the RARM Credit Card, the holder of will be able to remotely access their card to add or reduce fund from their available fund up to their approved limit. The remote access card prevents over use and unexpected indebtedness incurred by the primary card holder in the case where the RARM Card is given as a gift or to a minor. The remote access approach reduces excess loss to credit issuing institutions or even and individual gift givers such as parents or family members, who wish to allow family member(s) obtain money or credit. Moreover the control options allotted to the primary card holder facilitate fund transfer and offer the highest protection to funds when card holders are in transit, as funds can be remotely removed or added. The same holds true in the case of lost or stolen cards.

Due to the durability and versatility of the instant card and system described herein, this system could be adapted to become the future of employee payment, a paperless payroll that system. The card will have a typical computer chip for processing and durable Gold or Silver magnetic strips for reading purposes. The card will be preferably ducked, than swiped and this will provide added security against card skimmers as compared to other cards in circulation today.

Existing Credit Card issuing institutions will be encouraged to participate via a licensing agreements or some royalty arrangement to take advantage of the versatility and protection that the RARM Card provides. Thus, the RARM card is like carrying a bank ATM Card with you, without the load or risk of theft. With the RARM Card, you have peace of mind as you are in control of your money, far removed from the prowling eyes and hands of even the most cleaver criminal. In the case of travel or vacation, the RARM card is your best friend. You will be able to carry all the money you need without fear of having your money stolen as you are really not carrying the actual cash on your person. While going on vacation, the user is now able to load as much or as little money as needed, for only a nominal fee, paid to the administration of the system. This represents a refreshing alternative to carrying cash, credit card, money order or travelers checks.

You will also be able to buy in almost any currency at the present exchange rate as upon transfer, the exchange will be automatic, reducing the need to carry many different currencies and delay of looking for a place to change money.

Third world countries now will be able to safely introduce credit card systems administered to all, therefore helping to close the gap between the rich and the poor. Moreover, and not an originally intended feature of the invention, the RARM Card could be a good way to trade currency because foreign Exchange and fund transfer could be quick and timely. All that is required to transfer money is the card and a telephone. When used for purchases, a minimal fee is charged to the merchant. No fee is charged to the card holder at point of purchase.

This card is controlled by one central place, independent of any bank. Funds can be transferred for a bank or utilized in conjunction with a credit card. While traveling, you can keep the card empty. The chosen destination, you can place a desired amount of money on the card over the telephone.

There has thus been outlined, rather broadly, the more important features of the mixing system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

What is claimed is:

1. A credit containment card system comprising:
at least one credit containment card comprising an electronic communication means;
at least one electronic processing terminal apparatus configured to communicate with said at least one credit containment card, comprising:
at least one signal receiving port in communication with an electronic network;
at least one means for entering a security code;
means for transferring fund availability information to and from said at least one credit containment card;
an output display mechanism disposed to present information pertaining to authorization of said security code, an account balance for banks and credit card company accounts, and a balance of said at least one credit containment card;
a central administrative apparatus comprising at least one a computer, in electronic communication with said network comprising:
at least one data port capable of receiving and sending information wherein said data port is capable of communication with a banking institution account server and a credit card account server;
a data base containing predetermined security information pertaining to said at least one credit containment card;
an information processing apparatus capable of receiving and evaluating a security code, in conjunction with said database, for authorization of use of said credit containment card system for purchase in a selected institution wherein said information processing apparatus comprises capability to receive, send and process information regarding said banking institution accounts and credit card company accounts; and,
wherein said card is issued with no predetermined monetary value.

2. The credit containment card system of claim 1 wherein funds may be transferred from at least one banking institution account.

3. The credit containment card system of claim 1 wherein transfer of funds to and from said credit containment card is not limited to one destination bank.

4. The credit containment card system of claim 1 wherein funds may be transferred from at least one credit card company account.

5. The credit containment card system of claim 1 wherein funds may be transferred from at least one credit card company account and at least one banking institution account simultaneously.

6. The credit containment card system of claim 1 wherein funds may be transferred from a plurality of banking institution accounts simultaneously.

7. The credit containment card system of claim 1 wherein funds may be transferred from a plurality of one credit card company accounts simultaneously.

8. The credit containment card system of claim 1 wherein said at least one means for entering a security code means comprises an input for verification of a government issued identification card.

9. The credit containment card system of claim 1 wherein said at least one means for entering a security code comprises a keypad.

10. The credit containment card system of claim 1 wherein a transferal of funds allows for real time currency conversion to the country of receipt of funds with no charge to the user.

11. The credit containment card system of claim 1 wherein funds may be transferred to said credit containment card remotely by a user without possession of said credit containment card.

12. The credit containment card system of claim 1 wherein funds may be transferred from said credit containment card remotely by a user without possession of said credit containment card.

13. The credit containment card system of claim 1 wherein an original purchaser can allot access to said credit containment card to at least one sub-user.

14. The credit containment card system of claim 13 wherein said at least one sub-user comprises a plurality of sub-users.

15. The credit containment card system of claim 14 wherein an original purchaser can create a security number for said plurality of sub-users.

16. The credit containment card system of claim 13 wherein additional access numbers can be issued for said at least one sub-user.

17. An apparatus for processing a multi-fundable purchase card comprising:
at least one signal receiving port for receiving and reading said multi-fundable purchase card;
means for communication with an electronic network, said network in communication with at least one financial institution account and a data base comprising storage and a verification of at least one security code;
means for receipt of a listing of fund availability information from said at least one financial institution account;
means for transfer of funds to and from said at least one financial institution account;
means for entry of at least one security code; and,
means for display of information, wherein said means for display of information exhibits a balance of said at least one credit containment card, said listing of fund availability information and said verification of at least one security code;

18. An apparatus for processing a multi-fundable purchase card wherein said at least one financial institution is selected from the group consisting of banking institutions and credit card institutions.

19. An apparatus for processing a multi-fundable purchase card wherein said at least one financial institution is selected from the group consisting of banking institutions and credit card institutions.

20. A method of allotting international purchaceability comprising:
establishing at least one credit containment card for purchase by a user;
developing and maintaining a system of electronic signal receiving terminals capable of recognition, processing and transferal of information to and from said credit containment card;
networking said system of electronic signal receiving terminals with a remotely located administration system containing a database wherein said at least one electronic signal receiving apparatus further comprises a means for entry of a security access code;
networking said database to subscribing banks and credit card companies wherein upon reading said credit containment card, said electronic signal receiving apparatus affects account activation, fund replenishment and fund diminishment capabilities through the network; and,
conveying system data from said electronic signal receiving terminals to administration system, the information including identification of said credit containment card, security code of said credit containment card, credit containment card replenishment or credit containment card diminished.
